(19) United States
(12) Patent Application Publication
(10) Pub. No.: US 2012/0213110 A1
(43) Pub. Date: Aug. 23, 2012

(54) COMMUNICATION CHANNEL SELECTION DEVICE, METHOD, AND COMPUTER PROGRAM PRODUCT

(75) Inventor: Satoru YAMAGUCHI, Nagoya-shi (JP)

(73) Assignee: Buffalo Inc., Nagoya-shi (JP)

(21) Appl. No.: 13/402,552

(22) Filed: Feb. 22, 2012

(30) Foreign Application Priority Data
Feb. 23, 2011 (JP) 2011-37308

(51) Int. Cl. H04W 24/00

(52) U.S. Cl. 370/252

(57) ABSTRACT

A communication channel selection device, method and computer program product select a wireless communication channel among a plurality of communication channels with partially overlapping bandwidths in a frequency range available for use by an access point. A channel detector detects a busy channel used by another access point different from the access point. A signal strength detector detects a received signal strength of a wireless radio wave output from the another access point in the busy channel detected by the channel detector. A channel selector checks for a presence of a non-interfering channel that does not interfere with the detected busy channel, and when the channel selector does not detect the presence of the non-interfering channel, the channel selector selects the communication channel to be used by the access point based on the received signal strength of the wireless radio wave output in the busy channel.

### CROSS-REFERENCE TO RELATED APPLICATION

This application claims the priority based on Japanese Patent Application No. 2011-37308 filed on Feb. 23, 2011, the disclosure of which is hereby incorporated by reference in its entirety.

### BACKGROUND

1. Technical Field

The present disclosure relates to a technique of selecting a communication channel to be used by a wireless LAN device.

2. Related Art

A wireless LAN device that makes wireless communication in conformity with the wireless LAN standard can select a communication channel (hereinafter may be simply called a channel) to be used for wireless communication according to the environment. For example, an access point conforming to the IEEE802.11 standard and using the 2.4 GHz bandwidth may select a channel to be used among thirteen channels set at intervals of 5 MHz. The access point generally detects and uses one of unused channels that are not used by other access points. This causes no radio wave interference with the other access points and thereby suppresses deterioration of the communication performance. The channel selected by the access point is notified, for example, in the form of beacon, to a wireless station that intends to make communication with the access point.

When the access point selects a channel, there may be no unused channel. For example, plural other access points may be already present in the coverage area of the access point that is currently selecting a channel, so that the access point cannot find an available unused bandwidth required for communication, for example, 20 MHz bandwidth. Even in such cases, it is demanded to select an adequate channel for the communication quality as high as possible.

According to one proposed method, the access point calculates a simulated signal density with respect to each channel and selects a channel having the minimum simulated signal density as the channel to be used by the access point itself. The simulated signal density is obtained by a weighting calculation from the number of access points using each channel and the interval of busy channels. The method of selecting a channel based on such simulated signal density requires a predetermined amount of calculations. There is, as recognized by the present inventor, accordingly still room for improvement of simplifying the method. This problem is not limited to the wireless LAN device conforming to the IEEE802.11 standard but is commonly found in wireless LAN devices that are capable of selecting a channel among plural channels.

### SUMMARY

Consequently, by considering at least part of the foregoing, there is a need to simplify the method of selecting a communication channel having the communication efficiency of or above a certain level, as the communication channel to be used by the access point.

In order to achieve at least part of the foregoing, the present disclosure provides various aspects and embodiments described below.

In an apparatus embodiment, a communication channel selection device selects a wireless communication channel among a plurality of communication channels with partially overlapping bandwidths in a frequency range available for use by an access point, and includes

a channel detector that detects a busy channel used by another access point different from the access point;

a signal strength detector that detects a received signal strength of a wireless radio wave output from the another access point in the busy channel detected by the channel detector; and

a channel selector that checks for a presence of a non-interfering channel that does not interfere with the busy channel, and when the channel selector does not detect the presence of the non-interfering channel, the channel selector selects the communication channel to be used by the access point based on the received signal strength of the wireless radio wave output in the busy channel.

One aspect of the embodiment is that

the non-interfering channel is a channel having an unused bandwidth of a predetermined size.

Another aspect is that

the channel selector checks for the presence of the non-interfering channel, while regarding any channel having the received signal strength that is not higher than a predetermined value as a unused channel.

Another aspect is that

the channel selector selects the busy channel as the communication channel to be used by the access point when the received signal strength of the busy channel is not lower than a predetermined threshold.

Another aspect is that

the channel selector selects the busy channel as a channel to be used with collision avoidance control by the access point.

Another aspect is that

a prohibiter is included that prohibits selection of two busy channels among plural busy channels detected by the channel detector as the communication channel to be used by the access point, when the two busy channels are used by other access points in a mutually interfering range and mutually interfering frequency bands.

Another aspect is that

the channel selector selects a peripheral channel shifted by three or less channels from the busy channel as the communication channel to be used by the access point when the plurality of communication channels are four or more and the received signal strength is higher than a predetermined value but lower than a predetermined threshold value.

Another aspect is that

the signal strength detector detects the received signal strength only for the busy channel detected by the channel detector.

According to another embodiment a method is provided of selecting a wireless communication channel among a plurality of communication channels with partially overlapping bandwidths in a frequency range available for use by an access point, the method includes detecting a busy channel used by another access point different from the access point;

detecting with a signal strength detector a received signal strength of a wireless radio wave output from the another access point in the busy channel; and

checking for a presence of a non-interfering channel that does not interfere with the busy channel, and when the checking does not detect the presence of the non-interfering channel, selecting the communication channel to be used by the access point based on the received signal strength of the wireless radio wave output in the busy channel.

According to one aspect of the embodiment,

the non-interfering channel is a channel having an unused bandwidth of a predetermined size.

Another aspect is that

the detecting does not check for any channel having the received signal strength that is not higher than a predetermined value.

the checking for the presence of the non-interfering channel regards any channel having the received signal strength that is not higher than a predetermined value as a unused channel.

Another aspect is that

the selecting selects the busy channel as the communication channel to be used by the access point when the received signal strength of the busy channel is not lower than a predetermined threshold.

Another aspect is that

the selecting selects the busy channel as a channel to be used with collision avoidance control by the access point.

Another aspect is that

the prohibiting selection of two busy channels among plural busy channels as the communication channel to be used by the access point, when the two busy channels are used by other access points in a mutually interfering range and mutually interfering frequency bands.

Another aspect is that

the selecting selects a peripheral channel shifted by three or less channels from the busy channel as the communication channel to be used by the access point when the plurality of communication channels are four or more and the received signal strength is higher than a predetermined value but lower than a predetermined threshold value.

Another aspect is that

the detecting detects the received signal strength only for the busy channel.

In a non-transitory computer readable storage device embodiment, the device has computer readable instructions stored therein that when executed by a processing circuit implement a method of selecting a wireless communication channel among a plurality of communication channels with partially overlapping bandwidths in a frequency range available for use by an access point, the method includes

detecting a busy channel used by another access point different from the access point;

detecting with a signal strength detector a received signal strength of a wireless radio wave output from the another access point in the busy channel; and

checking for a presence of a non-interfering channel that does not interfere with the busy channel, and when the checking does not detect the presence of the non-interfering channel, selecting the communication channel to be used by the access point based on the received signal strength of the wireless radio wave output in the busy channel.

According to one aspect of the embodiment,

the non-interfering channel is a channel having an unused bandwidth of a predetermined size.

Another aspect is that

the detecting does not check for any channel having the received signal strength that is not higher than a predetermined value.

the checking for the presence of the non-interfering channel regards any channel having the received signal strength that is not higher than a predetermined value as a unused channel.

Another aspect is that

the selecting selects the busy channel as the communication channel to be used by the access point when the received signal strength of the busy channel is not lower than a predetermined threshold.

### BRIEF DESCRIPTION OF THE DRAWINGS

FIG. 1 illustrates the configuration of a network system including a computer according to one embodiment of the communication channel selection device of the invention;

FIG. 2 illustrates the general structure of the computer;

FIG. 3 is a flowchart showing an exemplary flow of channel notification process performed by the computer;

FIG. 4 is a flowchart showing an exemplary flow of channel selection process in the channel notification process;

FIG. 5 is a flowchart showing an exemplary flow of received strength-based selection process in the channel selection process;

FIG. 6 is a first concrete example as the detection result of busy channels;

FIG. 7 is a second concrete example as the detection result of busy channels;

FIG. 8 is a third concrete example as the detection result of busy channels;

FIG. 9 is a fourth concrete example as the detection result of busy channels;

FIG. 10 shows the detection results of RSSIs of respective channels in a first throughput measurement experiment;

FIG. 11 shows the measurement results of throughputs at the respective channels in the first throughput measurement experiment;

FIG. 12 shows the detection results of RSSIs of respective channels in a second throughput measurement experiment;

FIG. 13 shows the measurement results of throughputs at the respective channels in the second throughput measurement experiment;

FIG. 14 shows the detection results of RSSIs of respective channels in a third throughput measurement experiment; and

FIG. 15 shows the measurement results of throughputs at the respective channels in the third throughput measurement experiment.

### DETAILED DESCRIPTION

### A. Embodiment

A-1. General Configuration of Network System 20

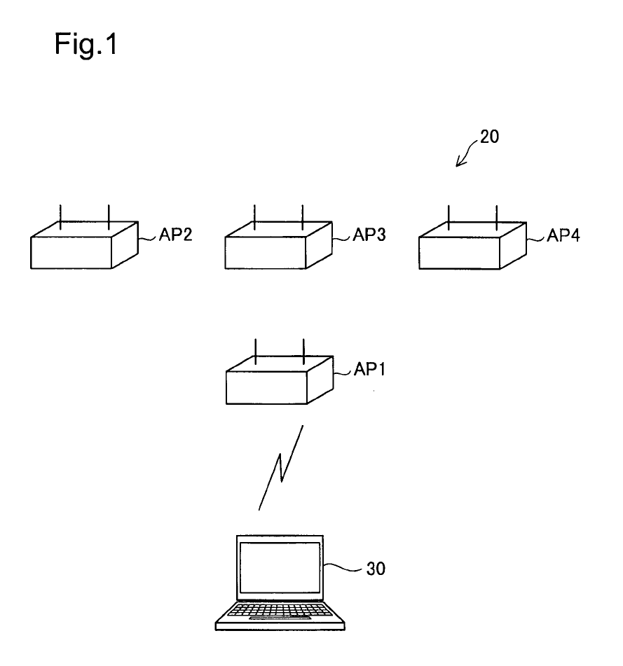

FIG. 1 illustrates a general configuration of a network system 20 using a computer 30 according to one embodiment of the communication channel selection device of the embodiment. As illustrated, the network system 20 includes a computer 30 and access points AP1 to AP4. The computer 30 internally has a wireless communication interface and serves as a station. Each of the access points AP1 to AP4 serves as a wireless access point to relay communication between stations. One or more wireless stations may be connected to each of the access points AP1 to AP4, although they are not illustrated in FIG. 1.

The access points AP2 to AP4 and the computer 30 are located in the coverage area of the access point AP1. The access points AP1 to AP4 may adopt WDS (Wireless Distribution System) for communication between the access points. The access points AP2 to AP4 may not necessarily belong to the same network as the access point AP1. For example, the access points AP2 to AP4 may belong to a different user, e.g., a neighbor, from that of the access point AP1. In this case, the access point AP1 and the access points AP2 to AP4 respectively belong to different networks.

The computer 30 and the access points AP1 to AP4 use 2.4 GHz bandwidth conforming to the IEEE802.11 standard for wireless communication in this embodiment. In the 2.4 GHz bandwidth, channels 1 to 13 set at the intervals of 5 MHz are selectable as a channel to be used by each access point.

A-2. General Structure of Computer 30

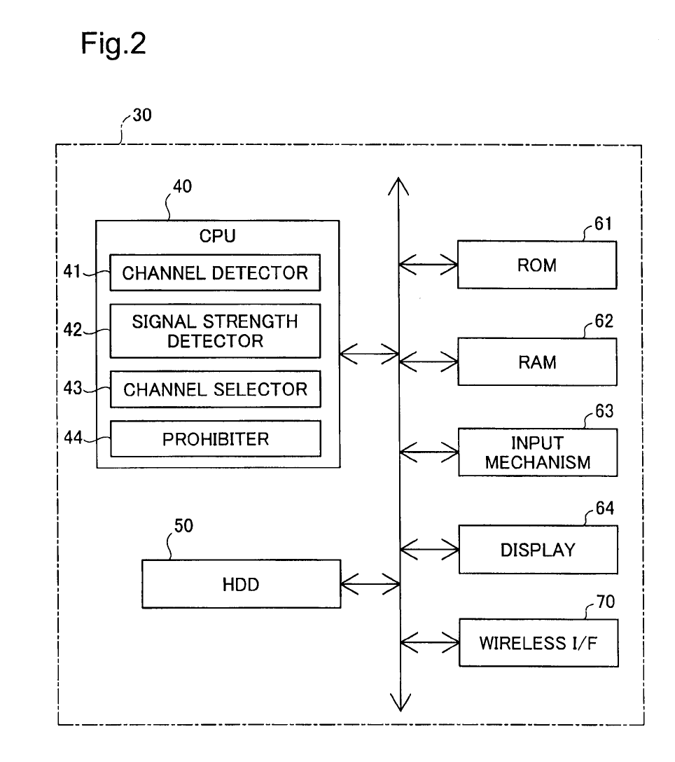

FIG. 2 illustrates the general structure of the computer 30. The computer 30 is a general-purpose personal computer with preset programs installed therein. As illustrated in FIG. 2, the computer 30 includes a CPU 40, a hard disk drive 50, a ROM 61, a RAM 62, an input mechanism 63, a display 64, and a wireless interface 70, which are interconnected by buses.

The CPU 40 loads the firmware and the OS stored in the hard disk drive 50 or the ROM 61 onto the RAM 62 and executes them, so as to control the whole computer 30. The CPU 40 also executes a program stored in the hard disk drive 50 to serve as a channel detector 41, a signal strength detector 42, a channel selector 43 and a prohibiter 44. The details of these functional blocks will be described later.

The OS and the program for actualizing the functions of the respective functional blocks are stored in the hard disk drive 50. The input mechanism 63 includes a keyboard and a pointing device, and the user can give operation commands to the computer 30 via the input mechanism 63. The display 64 is a liquid crystal display used to display, for example, the processing results of the computer 30 and various dialog boxes to ask for the user's entries.

The wireless interface 70 is a control circuit for making wireless communication in conformity with the wireless LAN standard and has hardware including a modulator, an amplifier, and an antenna. In this embodiment, the wireless interface 70 conforms to the IEEE802.11 standard. This wireless interface 70 serves as a station. The wireless interface 70 includes an RSSI detection circuit for detecting the RSSI (Received Signal Strength Indication) of received radio wave. The RSSI detection circuit may be provided separately from the wireless interface 70. In this embodiment, the wireless interface 70 is incorporated in the computer 30. The wireless interface 70 may be provided in a detachable manner. For example, the wireless interface 70 may be provided outside the casing of the computer 30 and connected to the computer 30 via a USB interface. Any suitable interface other than USB, e.g., IEEE1394 interface or Thunderbolt (trademark) interface, may alternatively be used for such connection.

A-3. Channel Notification Process

A channel notification process performed by the computer 30 is described. According to the channel notification process, the computer 30 selects a channel to be used by the access point AP1 and notifies the access point AP1 of the selected channel. The selection of the channel takes into account the RSSIs of the radio waves sent from any access points other than the access point AP1 (hereinafter called “other access points”) and the statuses of the busy channels respectively used by the other access points.

The embodiment describes the case in which the computer 30 selects a channel to be used by the access point AP1, when the access point AP1 is newly added to the network system 20 established to have the access points AP2 to AP4 in a communicable way.

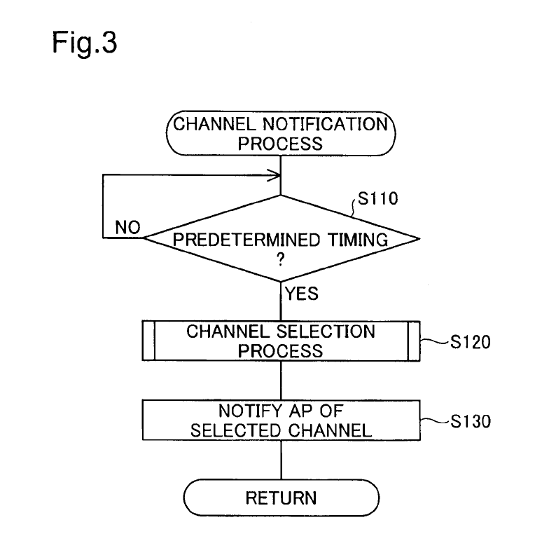

The flow of channel notification process is shown in FIG. 3. In this embodiment, the channel notification process is triggered when a specified program stored in the hard disk drive 50 is activated in the computer 30. On the start of the channel notification process, the CPU 40 of the computer 30 stands by until a predetermined timing (step S110).

In this embodiment, the predetermined timing denotes the timing when wireless connection information is set in the computer 30 to allow for communication between the computer 30 and the access point AP1. The predetermined timing may be the timing when the wireless connection information is automatically set between the computer 30 and the access point AP1 by, for example, the AOSS (AIRSTATION ONE-TOUCH SECURE SYSTEM, registered trademark by Buffalo Inc.) technology or WPS (Wi-Fi Protected Setup) technology. According to another embodiment, the wireless connection information may be set manually, and the “predetermined timing” may be the timing of completion of such setting or may be determined by the user's instruction accompanied with completion of the setting.

When detecting the predetermined timing (step S110), the CPU 40 performs channel selection process (step S120). This process selects a channel to be used by the access point AP1 among plural channels available for the access point AP1, i.e., the channels 1 to 13. The details of this process will be described later. Before performing the channel selection process, the CPU 40 may open GUI (Graphical User Interface) on the display 64 to receive the user's permission or rejection for performing the channel selection process. In this case, the computer 30 may display setting information for wireless communication such as identification information of the target access point AP1, e.g., SSID (Service Set Identifier), on the GUI.

After the channel selection process, the CPU 40 establishes connection with the access point AP1 and notifies the access point AP1 of the channel selected by the channel selection process (hereinafter called “selected channel”) (step S130). For the purpose of such notification, the CPU 40 may send, for example, a specific frame as a notice, which includes an identifier representing that the selected channel is to be notified and an identifier representing the selected channel, to the access point AP1.

The channel notification process is then terminated. The access point AP1 receives the notice from the computer 30 by the channel notification process and starts wireless communication using the selected channel included in the notice. More specifically, the access point AP1 starts sending beacon using the selected channel. This beacon includes a number representing the selected channel.

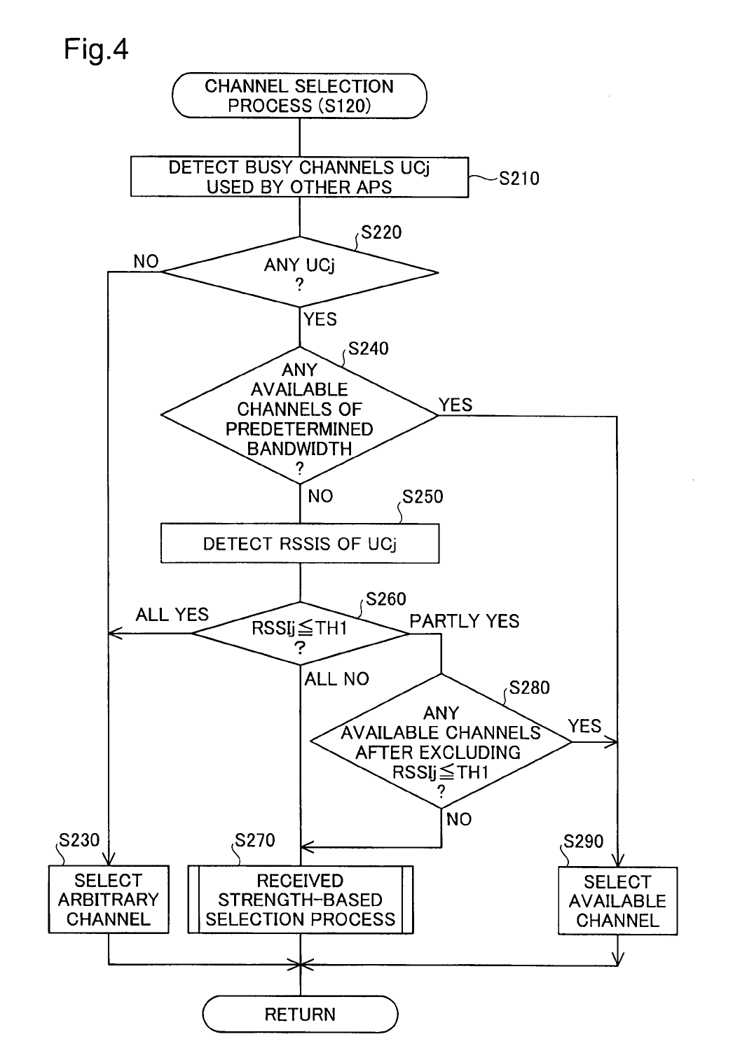

The channel selection process (step S120) performed in the channel notification process is described in detail. The flow of channel selection process is shown in FIG. 4. As illustrated, on the start of the channel selection process, the CPU 40 of the computer 30 or specifically its channel detector 41 detects busy channels UCj (where j denotes an integer in the range of 1 to 13 corresponding to the busy channel) used by the other access points (access points AP2 to AP4 in this embodiment) (step S210).

This process is implemented by active scan in this embodiment. More specifically, the CPU 40 sequentially sends a probe request with regard to each of the channels 1 to 13. Each of the other access points AP2 to AP4 sends back a probe response as a reply to this probe request. The CPU 40 receives the probe response and detects the busy channel UCj. The number representing the busy channel is included in the probe response according to the IEEE802.11 standard, so that the CPU 40 can readily detect the busy channel UCj. Since the number representing the busy channel is also included in the beacon, the CPU 40 may detect the busy channels UCj of the access points AP2 to AP4 by passive scan. Whether active scan or passive scan, when there is no access point using any of the channels 1 to 13, the detection of busy channels UCj (step S210) is ended after elapse of a predetermined time period as no detection of any possible busy channel UCj (Null).

After the detection of busy channels UCj (step S210) is ended, the CPU 40 checks whether any busy channel UCj is detected (step S220). No detection of busy channel UCj (step S220: No) means that the other access points AP2 to AP4 do not use any of the channels 1 to 13. Using any channel by the access point AP1 hence does not cause any radio wave interference with the other access points AP2 to AP4. The computer 30 accordingly selects an arbitrary channel, for example, channel 1, among the channels 1 to 13 (step S230).

Instead of selecting an arbitrary channel, the CPU 40 may alternatively notify the access point AP1 of a request for selection of an arbitrary channel by the access point AP1 at step S130 of the channel notification process described above.

When at least one busy channel UCj is detected (step S220: Yes), the CPU 40 checks whether there are unused channels of a predetermined bandwidth (step S240). The predetermined bandwidth depends on the bandwidth used by the access point AP1 for wireless communication. In this embodiment, the access point AP1 uses the about 20 MHz bandwidth for wireless communication. The predetermined bandwidth is thus 20 MHz bandwidth in this embodiment. When the access point AP1 uses the about 40 MHz bandwidth for wireless communication, the predetermined bandwidth will be 40 MHz bandwidth.

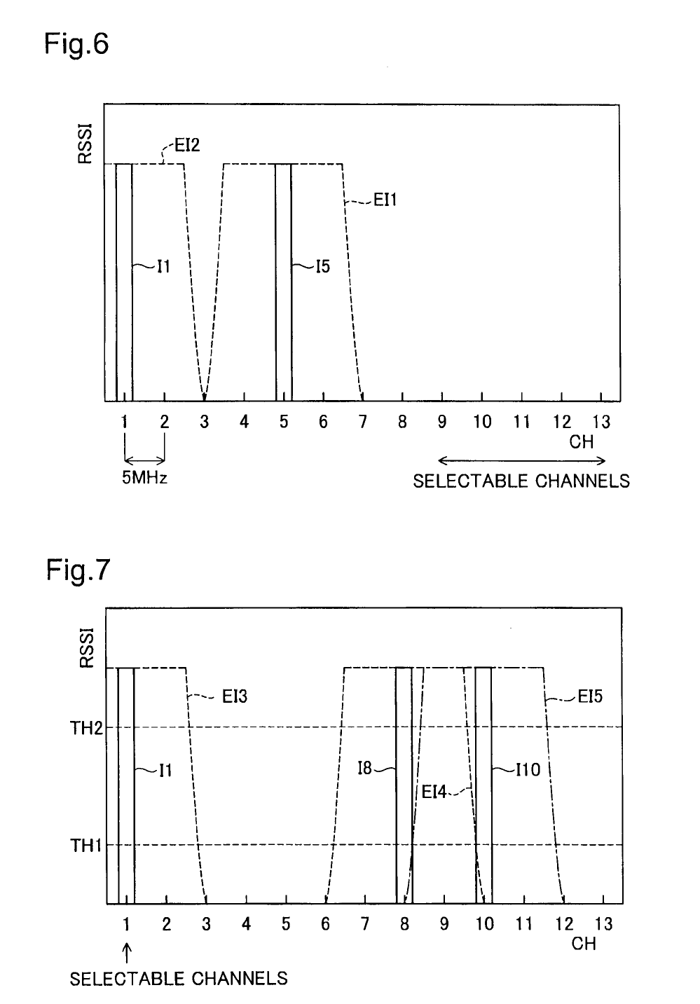

When there are unused channels of the predetermined bandwidth (step S240: Yes), the CPU 40 selects an arbitrary channel among the unused channels of the predetermined bandwidth (step S290). A concrete example of the selection at step S290 is described with reference to FIG. 6. FIG. 6 shows the case where the channels 1 and 5 are detected as the busy channels UCj at step S210. The abscissa and the ordinate of FIG. 6 respectively denote the channel and the RSSI. The RSSI, which has not yet been detected at step S290, is shown as the reference for the better understanding of FIG. 6.

In this embodiment, the access points AP2 to AP4 use the about 20 MHz bandwidth for wireless communication. When one of the access points AP2 to AP4 uses the channel 5, for example, the used bandwidth or the extent of the impact EI1 covers the 20 MHz bandwidth centering around the channel 5, i.e., the channel 3 to the channel 7, as shown in FIG. 6.

Similarly when one of the access points uses the channel 1, its extent of the impact EI2 covers the channel 1 to the channel 3. In the illustrated case of FIG. 6, the busy channels UC1 and UC5 use the bandwidth of channels 1 to 7, so that the unused channels are the channels 9 to 13. This means that any arbitrary channel among the unused channels 9 to 13 is selectable at step S290 in this case. The channel 8 is excluded, since using the channel 8 may cause an extent of the impact (channels 6 and 7) overlapping with the extent of the impact EI1 of the busy channel UC5, which may result in radio wave interference. Excluding the channel 9 from the selection will be further preferred in order to more effectively avoid the radio wave interference, although theoretically there is no possibility of causing an overlapping extent of the impact.

When there is no unused channel of the predetermined bandwidth (step S240: No), the CPU 40 or specifically the signal strength detector 42 uses the wireless interface 70 to detect the RSSIs (hereinafter referred to as RSSIj or simply as Ij) of the respective busy channels UCj corresponding to the strengths of the radio waves sent by the other access points AP2 to AP4 using these busy channels UCj (step S250). In this embodiment, the RSSIj is detected based on the beacon sent by each of the other access points AP2 to AP4 using the busy channels UCj. The RSSIj may be detected based on another communication frame, e.g., a probe response.

After detecting the RSSIj of the busy channels UCj, the CPU 40 checks whether each of the detected RSSIj is not higher than a predetermined value TH1 (step S260). This predetermined value TH1 is set as a value for specifying a level of weak radio wave that has no substantial effect on the quality of wireless communication. The radio wave with the RSSIj of not higher than the predetermined value TH1 has little effect on the quality of wireless communication. Even when a busy channel is detected, the radio wave of the busy channel with the RSSIj of not higher than the predetermined value TH1 can be regarded as not being present. The predetermined value TH1 is, for example, −81 dBm. The detection level of the RSSI differs among RSSI detection circuits. The predetermined value TH1 can thus be set adequately according to the properties of the RSSI detection circuit used for the computer 30.

When all the RSSIj are equal to or lower than the predetermined value TH1 (step S260: all Yes), the respective busy channels UCj can be regarded as not being used. The CPU 40 accordingly selects an arbitrary channel among the channels 1 to 13 (step S230).

When all the RSSIj are higher than the predetermined value TH1 (step S260: all No), none of the busy channels UCj is negligible. The CPU 40 accordingly performs received strength-based selection process (step S270). The received strength-based selection process selects a channel to be used by the access point AP1, based on the RSSIj of the busy channels UCj. The details of this process will be described later.

When plural busy channels UCj are detected and part of the RSSIj of the busy channels UCj are not higher than the predetermined value TH1 (step S260: partly Yes), the CPU 40 checks whether there are unused channels of the predetermined bandwidth when the RSSIj of not higher than the predetermined value TH1 are excluded or neglected (step S280). The same technique as that of step S240 is adopted to check for the presence or absence of unused channels.

When there are unused channels of the predetermined bandwidth after such exclusion (step S280: Yes), the CPU 40 proceeds to step S290 described above. When there is still no unused channel of the predetermined bandwidth even after such exclusion (step S280: No), on the other hand, the CPU 40 proceeds to step S270 described above. After selecting the channel to be used by the access point AP1 at any of steps S230, S270 and S290 described above, the CPU 40 terminates the channel selection process.

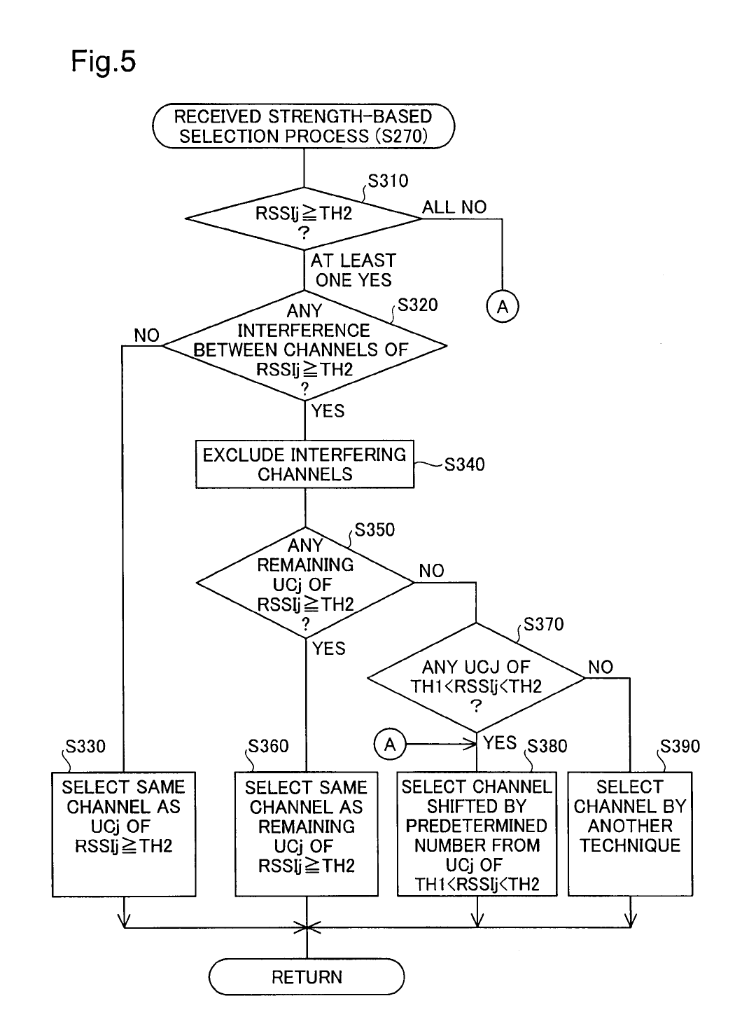

The received strength-based selection process (step S270) performed in the channel selection process is described in detail. The flow of received strength-based selection process is shown in FIG. 5. On the start of the received strength-based selection process, the CPU 40 first checks whether each of the RSSIj detected at step S250 is not lower than a threshold value TH2 (step S310). The threshold value TH2 is set as a value greater than the predetermined value TH1. In the description below, the radio wave with RSSIj of not lower than the threshold value TH2 is called “strong radio wave”. The radio wave with RSSIj of higher than the predetermined value TH1 but lower than the threshold value TH2 is called “medium radio wave”.

When at least one RSSIj is not lower than the threshold value TH2 (step S310: at least one Yes), the CPU 40 subsequently checks whether there is an interference between the busy channels UCj of the strong radio waves (step S320). Such check depends on the result of checking whether there is any overlap of the bandwidths used by the busy channels UCj of the strong radio waves. Such check may not be limited to interference between the busy channels UCj of the strong radio waves but may include interference between the busy channel UCj of the strong radio wave and the busy channel UCj of the medium radio wave. When there is no interference (step S320: No), the CPU 40 or specifically the channel selector 43 selects an identical channel with any busy channels UCj of the strong radio wave as the channel to be used by the access point AP1 (step S330).

Selecting an identical channel with the busy channel UCj of the strong radio wave used by any of the other access points AP2 to AP4 lowers the throughput of the access point AP1, compared with the case where the access point AP1 occupies the 20 MHz bandwidth centering around the selected channel. When the access point AP1 and the computer 30 use an identical channel with the busy channel UCj, however, collision of frames between the computer 30 and a wireless station making communication with another access point using the busy channel UCj is avoidable by access control. This ensures sufficient achievement of collision avoidance control by, for example, CSMA/CA (Carrier Sense Multiple Access/Collision Avoidance), RTS (Request to Send) or CTS (Clear to Send). The selected busy channel UCj has strong radio wave, so that it is highly probable that the computer 30 receives the radio wave of the wireless station, which makes communication with another access point using the busy channel UCj, at or over a certain level. This improves the accuracy of frame collision avoidance. When the access point AP1 uses the same channel as the busy channel UCj, a certain level of throughput can be ensured for communication of the access point AP1 or the computer 30 making communication with the access point AP1.

When the access point AP1 uses a channel slightly away from the busy channel UCj, for example, a channel shifted from the busy channel UCj by one channel or two channels, the channel used by the access point AP1 is different from the channels used by the other access points AP2 to AP4. The collision avoidance control such as CSMA/CA is enabled only between wireless LAN devices using the same channel, so that collision avoidance control does not work in this case. In the state without collision avoidance control, the strong radio waves of the other access points AP2 to AP4 cause significant noise for communication of the access point AP1. The higher RSSI causes the greater influence of the noise. When the access point AP1 uses a channel slightly away from the busy channel UCj, the throughputs of the access point AP1 and the computer 30 may be lowered significantly to cause failure of normal communication. In other words, when the busy channel UCj has strong radio wave, in order to achieve the stable throughput, it is preferable that the access point AP1 uses the same channel as the busy channel UCj to enable the collision avoidance control.

Accordingly at step S330, the CPU 40 selects an identical channel with one of the busy channels UCj of the strong radio wave, i.e., the busy channel with RSSIj of not lower than the threshold value TH2, as the channel to be used by the access point AP1.

When there is an interference (step S320: Yes), on the other hand, the CPU 40 or specifically the prohibiter 44 excludes the interfering busy channels UCj from the candidate of selection for the channel to be used by the access point AP1 (step S340). Such exclusion means selecting the interfering busy channels UCj of the strong radio waves as the channel to be used by the access point AP1 is prohibited.

After excluding the interfering busy channels UCj from the candidate of selection, the CPU 40 checks whether any busy channel UCj of the strong radio wave remains other than the excluded channels (step S350). When any busy channel UCj of the strong radio wave remains (step S350: Yes), the CPU 40 or specifically the channel selector 43 selects an identical channel with any remaining busy channel UCj of the strong radio wave, as the channel to be used by the access point AP1 (step S360).

The processing of steps S320 to S360 is described with reference to a concrete example. FIG. 7 shows the case where the channels 1, 8 and 10 are detected as the busy channels UCj at step S210. As illustrated, the detected values or RSSI values I1, I8 and I10 of the busy channels UC1, UC8 and UC10 are all not lower than the threshold value TH2 and are regarded as the strong radio waves. The detected values I1, I8 and I10 have the same level.

The extent of the impact EI3 of the busy channel UC1 does not overlap with the extents of the impact EI4 and EI5 of the other busy channels UC8 and UC10. In other words, the busy channel UC1 does not interfere with either of the other busy channels UC8 and UC10. Between the busy channels UC8 and UC10, however, there is interference in the channels 8 to 10 between the extent of the impact EI4 of the busy channel UC8 and the extent of the impact EI5 of the busy channel UC10. In other words, the busy channels UC8 and UC10 of the strong radio waves interfere with each other. In this case, the CPU 40 performs the processing of steps S320 and S340 to S360 to exclude the interfering busy channels UC8 and UC10 of the strong radio waves from the candidate of selection and selects the busy channel UC1 as the channel to be used by the access point AP1.

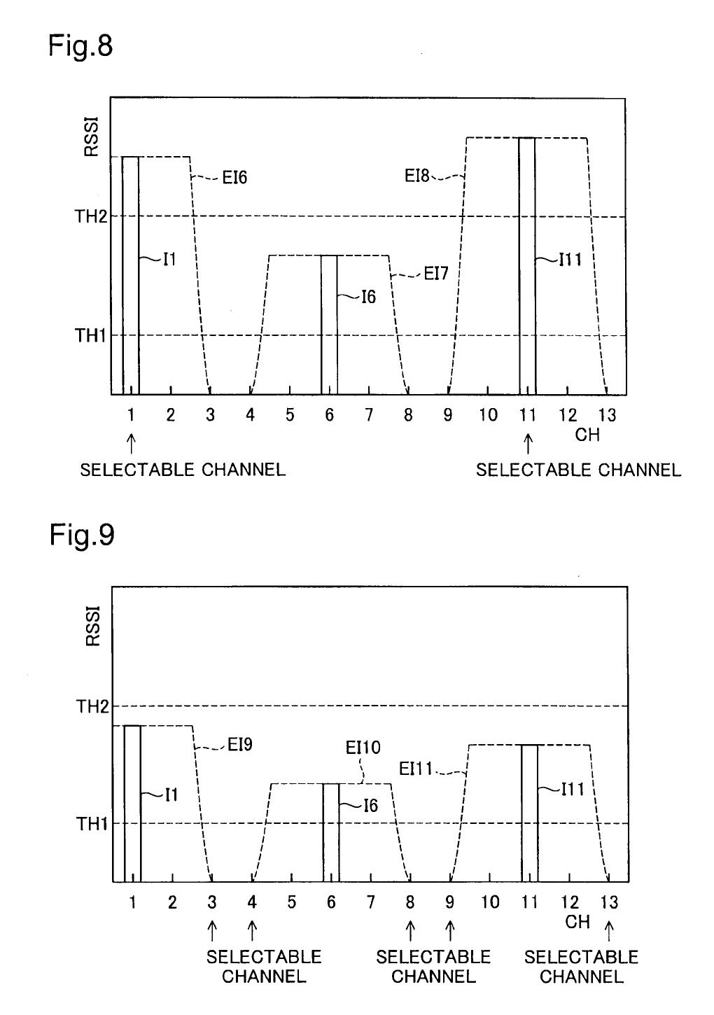

Another concrete example is shown in FIG. 8. FIG. 8 shows the case where the channels 1, 6 and 11 are detected as the busy channels UCj at step S210. As illustrated, among the detected values or RSSI values I1, I6 and I11 of the busy channels UC1, UC6 and UC11, the detected values I1 and I11 are not lower than the threshold value TH2 and are regarded as the strong radio waves. Between the detected values I1 and I11, the detected value I11 is relatively higher than the detected value I1. The detected value I6 is higher than the predetermined value TH1 but is lower than the threshold value TH2 and is regarded as the medium radio wave.

There is no overlap among the extent of the impact EI6 of the busy channel UC1, the extent of the impact EI7 of the busy channel UC6, and the extent of the impact EI8 of the busy channel UC11. In other words, there is no interference between the busy channels UC1 and UC11 of the strong radio waves. In this case, the CPU 40 performs the processing of steps S320 and S330 to select an arbitrary channel between the busy channels UC1 and UC11 as the channel to be used by the access point AP1. According to another embodiment, the busy channel UC11 having the relatively higher detected RSSI value may be selected preferentially. This is because the higher detected RSSI value enables the access point AP1 to more reliably detect the frame used for collision avoidance control by, for example, CSMA/CA, RTS or CTS and ensures the more effective collision avoidance control.

Referring back to the received strength-based selection process of FIG. 5, the following describes the series of processing when the result of checking whether any busy channel UCj of the strong radio wave remains (step S350) is No, i.e., there is no remaining busy channel UCj of the strong radio wave. In this case, the CPU 40 subsequently checks whether there is any busy channel UCj having the RSSIj of higher than the predetermined value TH1 but lower than the threshold value TH2, i.e., any busy channel UCj of the medium radio wave (step S370).

When there is any busy channel UCj of the medium radio wave (step S370: Yes), the CPU 40 or specifically the channel selector 43 selects any channel shifted by a predetermined number of channels from the busy channel UCj of the medium radio wave, as the channel to be used by the access point AP1 (step S380). In other words, when the busy channel UCj has the medium radio wave, the CPU 40 selects any channel shifted by a predetermined number of channels from the busy channel UCj, in place of the busy channel UCj to be selected when the busy channel UCj has the strong radio wave. The predetermined number of channels is two channels in this embodiment. When all the RSSIj are lower than the threshold value TH2 (step S310: all No), the CPU 40 also performs step S380 to select a channel as described above.

Selecting a channel shifted by the predetermined number of channels from the busy channel UCj of the medium radio wave used by any of the other access points AP2 to AP4 lowers the throughput of the access point AP1, compared with the case where the access point AP1 occupies the MHz bandwidth centering around the selected channel. Shifting from the busy channel UCj does not enable the collision avoidance control with respect to the busy channel UCj. The selected busy channel UCj, however, has the medium radio wave, which does not cause the noise of significantly lowering the quality of communication for the access point AP1 or the computer 30. When the access point AP1 uses the channel shifted by the predetermined number of channels, a certain level of throughput can be ensured for communication of the access point AP1 or the computer 30 making communication with the access point AP1.

When there is no busy channel UCj of the medium radio wave (step S370: No), on the other hand, the CPU 40 adopts another technique to select the channel to be used by the access point AP1 (step S390). Another technique may be, for example, the technique described in JP 2006-5603 mentioned above, i.e., selecting a channel based on the simulated signal density. After selecting the channel to be used by the access point AP1 at any of steps S330, S360, S380 and S390, the CPU 40 terminates the received strength-based selection process.

The processing of steps S370 to S380 is described with reference to a concrete example. FIG. 9 shows the case where the channels 1, 6 and 11 are detected as the busy channels UCj at step S210. As illustrated, the detected values or RSSI values I1, I6 and I11 of the busy channels UC1, UC6 and UC11 are all higher than the predetermined value TH1 but lower than the threshold value TH2 and are regarded as the medium radio waves. The detected value I1, I11 and I6 increase in this sequence. There is no interference among the extent of the impact EI9 of the busy channel UC1, the extent of the impact EI10 of the busy channel UC6 and the extent of the impact EI11 of the busy channel UC11.

In this case, the CPU 40 performs steps S310 and S380 to select the channel to be used by the access point AP1 in the following way. Specifically, the CPU 40 selects any of the channels 3, 4, 8, 9 and 13 shifted by the predetermined number of channels, i.e., two channels, from the busy channels UC1, UC6 and UC11. According to another embodiment, the channels 4 and 8 shifted by the predetermined number of channels from the busy channel UC6 having the relatively lower detected RSSI value may be selected preferentially. This is because the lower detected RSSI value causes the smaller noise for the access point AP1 or the computer 30, thus improving the throughput.

As clearly understood from the foregoing description, the threshold value TH2 is set as the criterion for determining the technique adopted for selecting the channel to ensure the throughput. When the RSSI is not lower than the threshold value TH2, the adopted technique selects the channel to enable the collision avoidance control for communication of the high throughput. When the RSSI is lower than the threshold value TH2, on the other hand, the adopted technique does not enable the collision avoidance control but selects the channel shifted by the predetermined number of channels from the busy channel UCj used by any of the other access points AP2 to AP4. In other words, the threshold value TH2 is set to prevent the throughput of the access point AP1 or the computer 30 from being lowered than a desired level when the channel shifted by the predetermined number of channels is used by the access point AP1. The threshold value TH2 may be, for example, −65 dBm. This threshold value TH2 may be experimentally set by taking into account the desired throughput and/or the detection characteristics of the RSSI detection circuits.

The predetermined number of channels is not limited to two channels. For example, the predetermined number may be one channel when the medium radio wave has low RSSI. Such setting relatively increases the noise caused by communication of another access point but enhances the degree of freedom for channel selection, compared with setting the predetermined number to two channels. At the low noise level, shifting by one channel ensures a certain extent of throughput. The predetermined number may be three channels. Such setting relatively decreases the noise and ensures the higher throughput, compared with setting the predetermined number to two channels. Setting the greater number of channels to the predetermined number, however, increases the possibility that the selected channel interferes with the extents of the impact of the other busy channels UCj. Setting the predetermined number to two channels achieves the good balance between the improved throughput and the avoidance of noise interference. This means that setting the predetermined number to two channels preferably ensures a certain level of throughput with high accuracy.

The predetermined number may be varied according to each detected RSSIj value. For example, the predetermined number may be set to one channel for RSSIj of lower than a predetermined level, while being set to two or more channels for RSSIj of not lower than the predetermined level. Such variable setting more effectively achieves the good balance between the improved throughput and the avoidance of noise interference.

The interference between the busy channels UCj may be considered at step S380. According to another embodiment, the CPU 40 may check whether the channel shifted by the predetermined number of channels from the busy channel UCj of the medium radio wave interferes with the strong radio wave. In this case, the interfering channel with the strong radio wave may be excluded from the candidate of channel selection. This more effectively ensures the quality of communication. According to still another embodiment, the CPU 40 may check whether the channel shifted by the predetermined number of channels from the busy channel UCj of the medium radio wave interferes with another medium radio wave. In this case, the interfering channel with another medium radio wave may be excluded from the candidate of channel selection or may have the lower priority of channel selection. This further enhances the quality of communication.

According to another embodiment, the predetermined number may be zero. Like step S330 described above, the CPU 40 may select the same channel as the busy channel UCj. This achieves a certain level of the collision avoidance control and hence ensures the throughput of or above a certain level. Such setting may be adopted when the channel shifted by the predetermined number of channels from the busy channel UCj of the medium radio wave interferes with plural (for example, two) other medium radio waves. When the channel shifted by the predetermined number of channels from the busy channel UCj of the medium radio wave interferes with plural other medium radio waves, there is a possibility that the increased noise results in the significantly lowered throughput. Such setting effectively prevents a significant decrease of the throughput and ensures a certain level of throughput with higher accuracy.

A-4. Advantageous Effects

When there is no communication channel with RSSI of not higher than the predetermined value TH1 within the predetermined bandwidth, the computer 30 selects a communication channel according to the RSSIj of the busy channels UCj used by the access points AP2 to AP4. The access point AP1 is notified of the selected communication channel and uses the notified channel to allow for communication with the high throughput. The RSSIj of the busy channel UCj can be detected easily. Additionally, the radio waves of communication of the other access points AP2 to AP4, which may cause noise in communication of the access point AP1, can be detected with high accuracy, based on the RSSIj. The communication channel with the communication efficiency of or above a certain level can thus be selected as the channel to be used by the access point AP1 by the simple procedure.

When the RSSIj of the busy channel UCj is not lower than the threshold value TH2, the computer 30 selects the same channel as the busy channel UCj used by any of the other access points AP2 to AP4, as the channel to be used by the access point AP1. This results in enabling the collision avoidance control between the access points using the same channel. Additionally, the selected busy channel UCj with the RSSIj of not lower than the threshold value TH2 ensures sufficient achievement of the collision avoidance control. The communication efficiency of or above a certain level can be ensured even when there is no unused channel.

When the bandwidths of the two busy channels UCj are within the mutually interfering range among the detected plural busy channels UCj, the computer 30 prohibits selection of either of these two communication channels. This avoids the decrease of the communication efficiency due to selection of one of the channels in the mutually interfering range. This can avoid insufficient functionality of the collision avoidance control with respect to the other busy channel UCj when the access point AP1 uses the same channel as one of the interfering busy channels UCj. In this case, the computer 30 avoids the decrease of the communication efficiency of the access point AP1 due to the significant noise, which may be caused by the other busy channel UCj having the RSSIj of not lower than the threshold value TH2.

When the RSSIj of the busy channel UCj is higher than the predetermined value TH1 but is lower than the threshold value TH2, the computer 30 selects a channel shifted by a predetermined number of channels that is not less than one and not greater than three from the busy channel UCj. The threshold value TH2 is set, such that the radio waves of the other access points AP2 to AP4 do not cause any significant problem for communication of the access point AP1. When the shift amount of the selected channel is three or a less number of channels, there is little possibility that the selected channel interferes with the busy channels UCj used by the other access points AP2 to AP4. As the results, using the selected channel for communication enables the access point AP1 to have the throughput of or above a certain level. Although selecting a channel shifted from the busy channel UCj does not enable the collision avoidance control with respect to the busy channel UCj, the access point AP1 can make communication with the throughput of or above a certain level in this state.

Additionally, the computer 30 detects the RSSIs for only the detected busy channels UCj. This does not require detection of the RSSIs with respect to all the channels and can thus simplify the channel selection process and significantly shorten the time period required for the channel selection process.

The throughput measurement experiments were performed in order to verify the functionalities of the computer 30 described above. The results of the experiments are described below. This throughput measurement experiment set specified environments and measured the throughput of communication between the computer 30 and the access point AP1 using the channels 1 to 13. Three patterns were set as the environments. In the description hereinafter, these environments are called first to third environments. The busy channels used by the other access points AP2 to AP4 were variably set in the first to the third environments, as described later in detail. The distances between the access point AP1 and the other access points AP2 to AP4 were also variably set in the first to the third environments. Changing the distance means varying the magnitude of the RSSIj detected by the computer 30.

LLTD (Link Layer Topology Discovery) was used for measurement of the throughput. Specifically the throughput was measured according to the following procedure:

(A) The computer 30 sends an INIT frame to the access point AP1, and the access point AP1 sends back a READY frame to the computer 30;

(B) The computer 30 receives the READY frame and sends a 1500-byte PROBE frame to the access point AP1 up to 32 times;

(C) The access point AP1 records each receipt time of the PROBE frame;

(D) After completion of sending the PROBE frame, the computer 30 sends a QUERY frame to the access point APE

(E) When receiving the QUERY frame, the access point AP1 sends back a QUERY_RESPONSE frame to the computer 30. The QUERY_RESPONSE frame includes up to 32 receipt times of the PROBE frame;

(F) When receiving the QUERY_RESPONSE frame, the computer 30 sends a RESET frame to the access point AP1;

(G) When receiving the RESET frame, the access point AP1 sends back an ACK frame to the computer 30; and

(H) After completion of the above series of transmissions, the throughput is calculated according to Equation (1) below:

Throughput=Capacity of PROBE Frame (1500 bytes)×Number of PROBE frames sent/(Last Receipt Time of PROBE Frame−First Receipt Time of PROBE Frame) (1)

The experiment measured the throughput 100 times with respect to each channel according to the procedure of (A) to (H). The throughput shown below as the result of the experiment is the average value of the throughputs measured 100 times. Among the frames transmitted between the computer 30 and the access point AP1, those other than the PROBE frames are hereinafter called management frames.

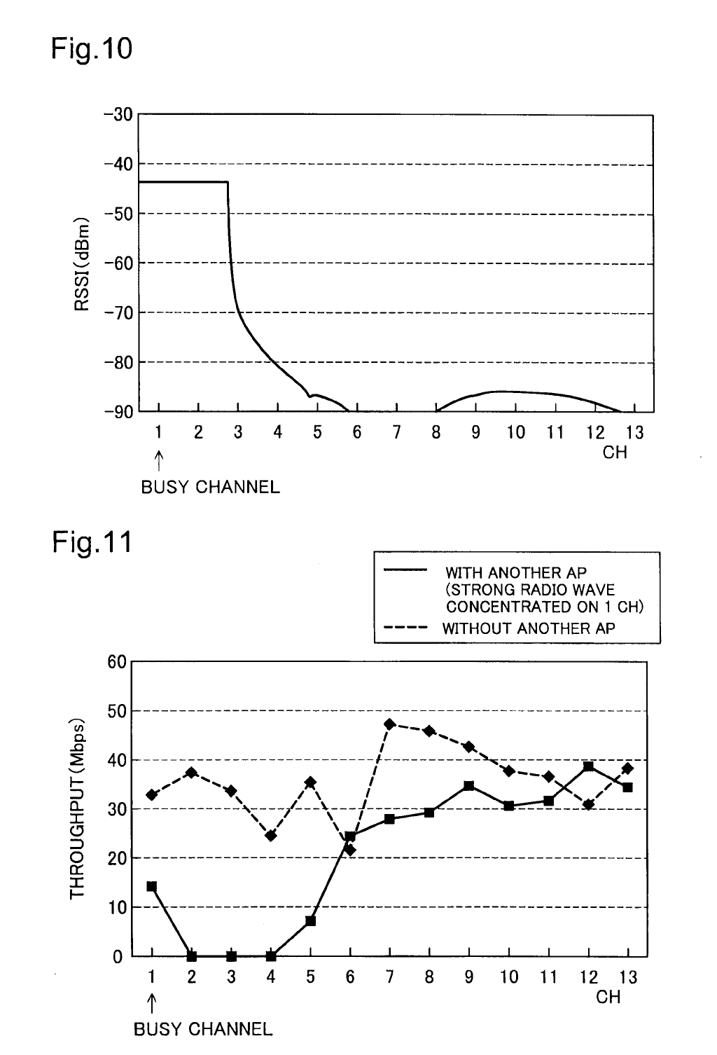

FIG. 10 shows the results of detection of the RSSIs of the respective channels by the computer 30 in the first environment. In the first environment, all the other access points AP2 to AP4 used the channel 1. Any of the channels 2 to 13 other than the channel 1 were not used. The busy channel UC1 used by the other access points AP2 to AP4 had the RSSI1 of −47 dBm. This RSSI1 indicates the strong radio wave.

FIG. 11 shows the throughputs measured for the respective channels 1 to 13 in the first environment. FIG. 11 shows the throughputs during stop of the other access points AP2 to AP4, i.e., the throughputs without the other access points AP2 to AP4, in addition to the throughputs during operations of the other access points AP2 to AP4.

As shown in FIG. 11, the throughput during operations of the other access points AP2 to AP4 was about 15 Mbps when the computer 30 and the access point AP1 used the busy channel UC1. The channels 2 to 3 in the extent of the impact of the busy channel UC1 had the throughputs of about 0 Mbps. The unused channels 6 to 13 had the throughputs of about 25 to 40 Mbps.

These results of the experiment show that the high throughput is obtained by the access point AP1 using an unused channel if any. These results also show that the throughput of a certain level is obtained by using the busy channel UC1 of the strong radio wave. In other words, the results of FIG. 11 demonstrate the validity of the channel selection at step S290 and at steps S330 and S360.

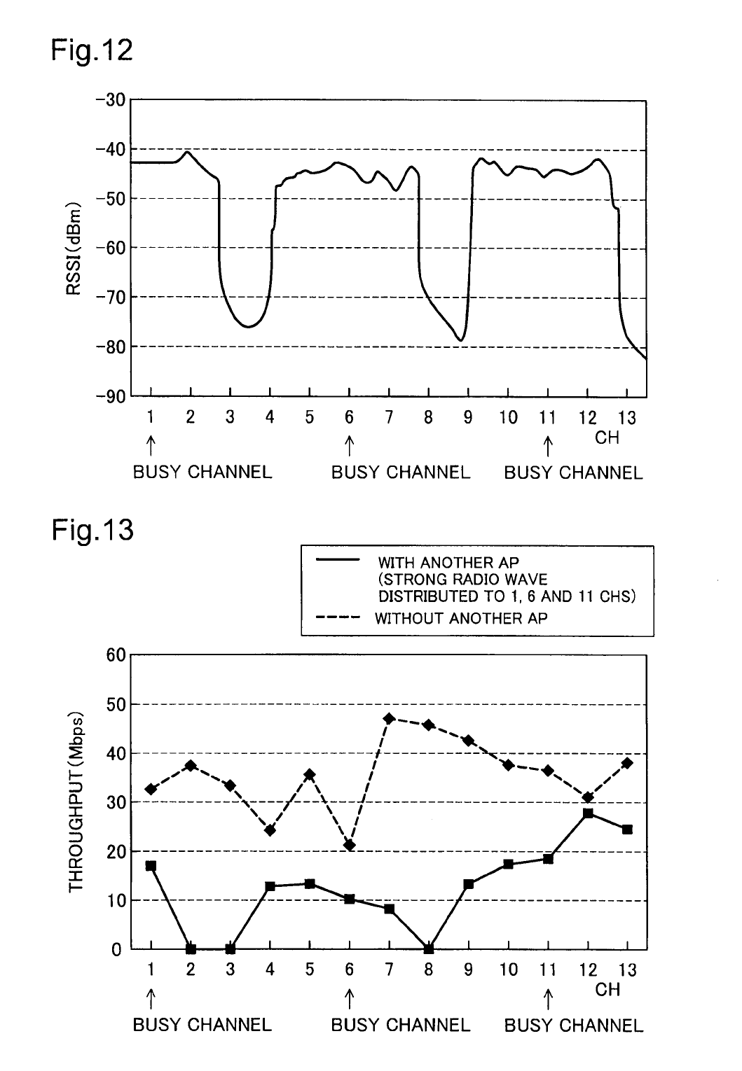

FIG. 12 shows the results of detection of the RSSIs of the respective channels by the computer 30 in the second environment. In the second environment, the other access points AP2, AP3 and AP4 respectively used the channels 1, 6 and 11. The RSSI1, RSSI6 and RSSI11 of the busy channels UC1, UC6 and UC11 used by the other access points AP2, AP3 and AP4 were in the range of −50 to −40 dBm. These RSSI1, RSSI6 and RSS11 indicate the strong radio waves.

FIG. 13 shows the throughputs measured for the respective channels 1 to 13 in the second environment. As shown in FIG. 13, the throughput was about 10 to 20 Mbps when the computer 30 and the access point AP1 used the busy channel UC1, UC6 or UC11.

The channels 4, 5, 7, 9, 10, 12 and 13 apparently had the throughputs of about 10 to 30 Mbps but cannot actually make adequate wireless communication as described below. The measurement of the throughput according to the above procedure of (A) to (H) does not consider the transmission time or reception time. Even when reception or transmission of the management frame is tried many times and takes a long time due to the noise caused by the radio waves of the other access points AP2 to AP4, the reception time or transmission time of the management frame is not reflected on the throughput. When the PROBE frame is received at least twice, the throughput can be calculated from the first receipt time and the last receipt time. The higher apparent throughput than the actual throughput may thus be calculated. This experiment took the significantly longer measurement time for the channels 4, 5, 7, 9, 10, 12 and 13 than the measurement time for the busy channels 1, 6 and 11. This indicates that transmission and reception of the management frame required a long time period. In other words, this indicates failure of adequate wireless communication.

These results of the experiment show that the throughput of a certain level is obtained by the access point AP1 using the busy channels UC1, UC6 and UC11 of the strong radio waves even when there is no unused channel. In other words, the results of FIG. 13 demonstrate the validity of the channel selection at steps S330 and S360.

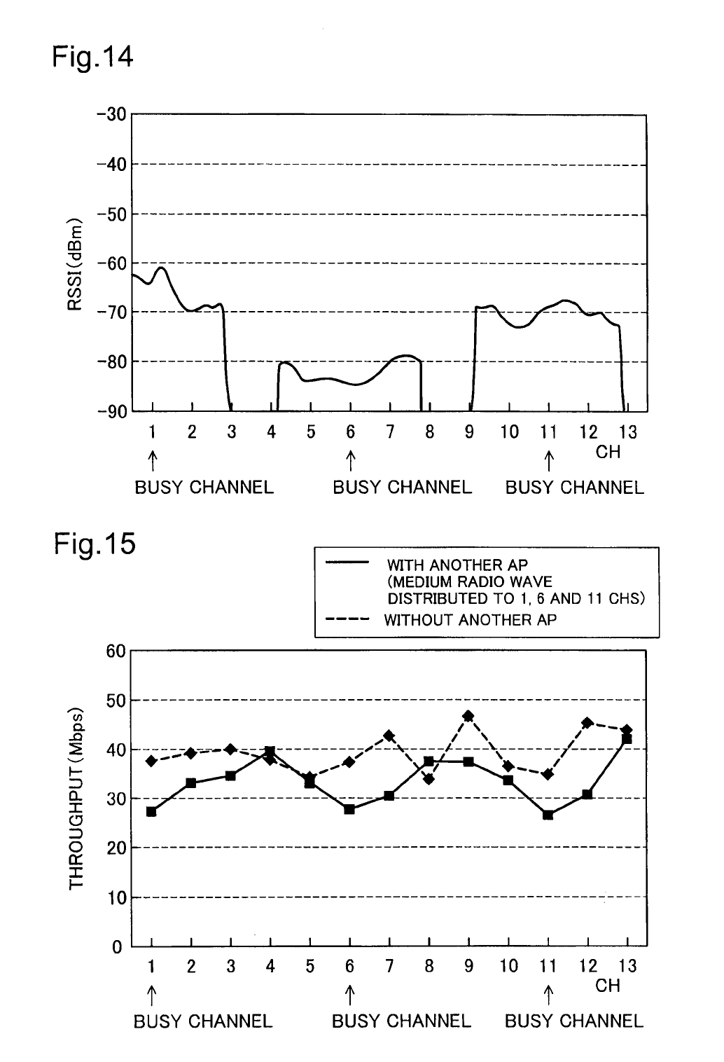

FIG. 14 shows the results of detection of the RSSIs of the respective channels by the computer 30 in the third environment. In the third environment, the other access points AP2, AP3 and AP4 respectively used the channels 1, 6 and 11. The RSSI1, RSSI6 and RSSI11 of the busy channels UC1, UC6 and UC11 used by the other access points AP2, AP3 and AP4 were in the range of −85 to −60 dBm. These RSSI1, RSSI6 and RSS11 indicate the medium radio waves.

FIG. 15 shows the throughputs measured for the respective channels 1 to 13 in the third environment. As shown in FIG. 15, the throughput was about 30 to 40 Mbps when the computer 30 and the access point AP1 used any of the channels 2 to 5, 7 to 10, 12 and 13 shifted by one to three channels from the respective busy channels UC1, UC6 and UC11. The throughput was about 27 Mbps when the computer 30 and the access point AP1 used any of the busy channels UC1, UC6 and UC11. This means that using any of the channels 2 to 5, 7 to 10, 12 and 13 has the higher throughput than using any of the busy channels UC1, UC6 and UC11.

These results of the experiment show that the throughput of a certain level is obtained by the access point AP1 using any of the channels 2 to 5, 7 to 10, 12 and 13 shifted by one to three channels from the respective busy channels UC1, UC6 and UC11 of the medium radio waves. These results also show that when the RSSIj of the busy channel UCj indicates the medium radio wave, using any of the channels shifted by one to three channels from the busy channel UCj has the higher throughput than using the busy channel UCj. In other words, the results of FIG. 15 demonstrate the validity of the channel selection at step S380.

### B. Variants

Variants of the above embodiment are described below.

### B-1. Variant 1:

The bandwidth used by the access points AP1 to AP4 is 20 MHz in the embodiment described above, but the bandwidth is not limited to 20 MHz. For example, when part or all of the access points AP1 to AP4 conform to the IEEE802.11n standard, the bandwidth may be 40 MHz. In the IEEE802.11n standard, information showing whether the access point uses the 40 MHz bandwidth is included in HT (High Throughput) Capability incorporated in IE (Information Element) of the beacon. The application with the 40 MHz bandwidth uses two channels, i.e., a common channel commonly used during the 20 MHz bandwidth and during the 40 MHz bandwidth and an extended channel. The extended channel may be set to any of the common channel±4 channels. Information showing which of the common channel±4 channels is set to the extended channel is included in HT Information of the beacon.

The computer 30 may accordingly refer to the beacon and check whether the access points AP1 to AP4 use the 40 MHz bandwidth. The computer 30 may also refer to the beacon and be informed of the common channel and the extended channel. When any of the access points AP2 to AP4 uses the 40 MHz bandwidth, the channel notification process may be performed with regarding the extent of the impact of this access point as the 40 MHz bandwidth centering about a middle channel between the common channel and the extended channel.

The computer 30 may select the common channel and the extended channel as the channels to be used. For example, in the case of selecting the same channel as any of the busy channels of the strong radio waves, the computer 30 may select two channels identical with the common channel and the extended channel used by any of the other access points AP2 to AP4.

When the access point AP1 is capable of using the 40 MHz bandwidth, the computer 30 may select which of the 20 MHz bandwidth and the 40 MHz bandwidth is to be used by the access point AP1, along with the channel selection. For example, the computer 30 may select the 40 MHz bandwidth when there are sufficient unused channels. In another example, the computer 30 may select the 20 MHz bandwidth when there are no sufficient unused channels or when using the 40 MHz bandwidth causes interference with the strong radio wave of another access point. This ensures the more flexible channel selection, according to the environment of the access point AP1.

### B-2. Variant 2:

In the above embodiment, the predetermined timing of the channel notification process (step S110 in FIG. 3) is the timing when the wireless connection information is set in the computer 30. This allows for channel selection of the access point AP1 on the start of using either the access point AP1 or the computer 30, thus improving the user's convenience. The predetermined timing may, however, be set arbitrarily.

For example, the computer 30 may perform the channel notification process at regular intervals. This effectively responds to a change in communication environment of the network system 20 and allows for selection of the optimum channel. In another example, the computer 30 may monitor the throughput of communication with the access point AP1 and perform the channel notification process when the throughput is lowered to or below a predetermined level. This also effectively responds to a change in communication environment of the network system 20 and allows for selection of the optimum channel. The identification information, such as MAC address or SSID of the access point as the subject of channel selection may be registered in advance in the computer 30.

In the network system 20 including a large number of access points, a number of access points may use the same channel as one busy channel in an overlapping manner by the channel notification process. This lowers the throughput, so that the computer 30 may perform the channel notification process again to review the channel selection. In this case, the computer 30 may prohibit selection of the same channel as the channel selected in the previous cycle of the received strength-based selection process. In other words, the computer 30 may exclude this same channel from the candidate of selection.

The method of preventing the overlapped use of the same channel as one busy channel by a number of access points is not limited to the procedure of monitoring the throughput as described above. One modified procedure may set an upper limit to the number of the access points using the same channel and cause the computer 30 to exclude the same channel from the candidate of selection when selection of the same channel exceeds the upper limit.

### B-3. Variant 3:

In the embodiment described above, the computer 30 detects the RSSIs for only the busy channels UCj (step S250 in FIG. 4). Alternatively the computer 30 may detect the RSSIs for all the channels. This actually measures the extent of the impact of each busy channel UCj, thus improving the accuracy of the channel selection. This also allows for detection of the background noise of all the channels, so that excluding any channel having the large background noise from the candidate of channel selection further improves the accuracy of the channel selection.

### B-4. Variant 4:

Performing the above channel notification process alone can select a channel having the communication efficiency of or above a certain level by the simple procedure. The channel notification process may, however, be combined with another method. For example, the combined method may make communication between the computer 30 and the access point AP1 with successively changing the channel to measure the throughputs of all the channels and may select a channel with the highest throughput. More specifically, the throughputs may be measured for only plural candidates of the channel selection specified by the above received strength-based selection process (for example, for only the channels 1 and 11 in the example of FIG. 8), and the channel having the highest throughput may be selected. This significantly reduces the number of throughput measurements (i.e., the number of channels to be measured) and the measurement time.

### B-5. Variant 5:

The above embodiment describes the channel selection of the access point AP1 using the 2.4 GHz bandwidth, but the method of selecting the same channel as the busy channel UCj may also be adopted for channel selection of an access point using the 5 GHz bandwidth.

### B-6. Variant 6:

Although the computer 30 using the wireless interface 70 performs the channel notification process in the above embodiment, the communication channel selection device of the invention is not limited to the personal computer but may be configured by a variety of stations, for example, an Ethernet converter (Ethernet is registered trademark). The communication channel selection device of the invention may alternatively be configured by an access point. In this case, the access point itself may perform the channel selection process to select a channel to be used by the access point itself. The computer 30 and the access point AP1 may have wired connection using a USB cable. According to another embodiment, the computer 30 may select a communication channel and store the selected communication channel in a storage medium, such as a USB memory, and the access point AP1 may read and set the selected communication channel from the storage medium connected to the access point AP1. The stored information is not limited to the value representing the selected communication channel but may include, for example, a WEP key for encryption.

The invention provides various aspect described below. [1] According to another aspect of the invention, there may be provided with a communication channel selection device of selecting a communication channel to be used by an access point making wireless communication among plural communication channels assigned to a preset frequency range to have bandwidths partly overlapped, comprising: a channel detector for detecting a busy channel used by another access point different from the access point; a signal strength detector for detecting received signal strength of wireless radio wave output from the another access point in the detected busy channel; and a channel selector for checking presence or absence of any non-interfering channel with the detected busy channel, and in the absence of any non-interfering channel, selecting the communication channel to be used by the access point, based on the received signal strength of the busy channel.

In the absence of any non-interfering channel with the detected busy channel, the communication channel selection device according to this aspect selects the communication channel to be used by the access point, based on the received signal strength of the busy channel. The received signal strength of the busy channel can be detected easily. The communication channel with the communication efficiency of or above a certain level can thus be selected as the channel to be used by the access point by the simple procedure.

[2] The non-interfering channel may be a channel having a predetermined unused bandwidth. A predetermined bandwidth is generally used for wireless communication, so that this effectively prevents the noise caused by the radio wave involved in communication of another access point.

[3] When there is any busy channel having the received signal strength of not higher than a predetermined value, this busy channel may be excluded from the subject of checking the presence or the absence of any non-interfering channel. In this case, the state of the radio wave involved in communication of another access point, which may be the source of noise, can be detected with high accuracy based on the received signal strength.

[4] When the received signal strength of the detected busy channel is not lower than a predetermined threshold value that is greater than the predetermined value, the channel selector may select the busy channel as the communication channel to be used by the access point.

The communication channel selection device according to this embodiment selects the same channel as the busy channel used by another access point, thus enabling the collision avoidance control. Additionally, the selected busy channel has the received signal strength of not lower than the predetermined threshold value, which ensures the sufficient achievement of collision avoidance control. This accordingly ensures the communication efficiency of or over a certain level.

[5] The communication channel selection device may further comprises a prohibiter for prohibiting selection of two busy channels among plural busy channels detected by the channel detector, as the communication channel to be used by the access point, when the two busy channels are in a mutually interfering range where the bandwidths of other access points using the two busy channels interfere with each other.

Selecting the same channel as one of the mutually interfering busy channels enables the collision avoidance control with respect to the one busy channel, but results in insufficient functionality of the collision avoidance control with respect to the other busy channel. Additionally, the other busy channel has the received signal strength of not lower than the predetermined threshold value and causes large noise for the access point, which may lower the communication efficiency. The communication channel selection device according to the above embodiment [5], however, does not select the same channel as any of the mutually interfering busy channels. This accordingly avoids the decrease of the communication efficiency.

[6] In the communication channel selection device, when the plural channels are four or more channels and the received signal strength of the detected busy channel is higher than the predetermined value but is lower than the predetermined threshold value, the channel selector may select a peripheral channel shifted by a number of channels, which is not greater than three, from the busy channel, as the communication channel to be used by the access point.

The communication channel selection device according to this embodiment selects a peripheral channel shifted from the busy channel used by another access point, so that the collision avoidance control is not enabled with respect to the busy channel. Adequate setting of the threshold value, however, allows for the channel selection, such that the radio wave of another access point does not cause significant noise that remarkably lowers the communication quality of the access point. When the shift amount of the selected channel is not three or a less number of channels, there is little possibility that the selected channel interferes with the busy channel of still another access point. This results in ensuring the throughput of or over a certain level.

[7] The signal strength detector may detect the received signal strength only for the detected busy channel. The communication channel selection device according to this embodiment does not require detection of the received signal strength for all the channels, thus simplifying the processing flow and significantly shortening the time period required for the channel selection.

The invention may be implemented by diversity of aspects and embodiments other than the communication channel selection device described above, for example, a communication channel selection method, a communication channel selection program, a recording medium in which the program is recorded, or an access point. Any of the features according to the embodiments [2] to [7] may be added alone or in combination to the above aspect [1] or any of these other aspects.

The foregoing has described in detail illustrative embodiments and variants. Among the various elements of the above embodiments and variants, not all of the elements are essential to practice variants on the disclosed embodiments. The invention is not limited to the above embodiments and variants, but a multiplicity of other variants and modifications may be made to the embodiments without departing from the scope of the invention. For example, the invention may be implemented by diversity of other applications, e.g., a communication channel selection method, a communication channel selection program, and a recording medium in which the program is recorded, in addition to the communication channel selection device.

1. A communication channel selection device that selects a wireless communication channel among a plurality of communication channels with partially overlapping bandwidths in a frequency range available for use by an access point, comprising:
a channel detector that detects a busy channel used by another access point different from the access point;
a signal strength detector that detects a received signal strength of a wireless radio wave output from the another access point in the busy channel detected by the channel detector; and
a channel selector that checks for a presence of a non-interfering channel that does not interfere with the busy channel, and when the channel selector does not detect the presence of the non-interfering channel, the channel selector selects the communication channel to be used by the access point based on the received signal strength of the wireless radio wave output in the busy channel.

2. The communication channel selection device of claim 1, wherein
the non-interfering channel is a channel having an unused bandwidth of a predetermined size.

3. The communication channel selection device of claim 1, wherein
the channel selector checks for the presence of the non-interfering channel, while regarding any channel having the received signal strength that is not higher than a predetermined value as a unused channel.

4. The communication channel selection device of claim 1, wherein
the channel selector selects the busy channel as the communication channel to be used by the access point when the received signal strength of the busy channel is not lower than a predetermined threshold.

5. The communication channel selection device of claim 4, wherein
the channel selector selects the busy channel as a channel to be used with collision avoidance control by the access point.

6. The communication channel selection device of claim 4, further comprising:
a prohibiter that prohibits selection of two busy channels among plural busy channels detected by the channel detector as the communication channel to be used by the access point, when the two busy channels are used by other access points in a mutually interfering range and mutually interfering frequency bands.

7. The communication channel selection device of claim 1, wherein
the channel selector selects a peripheral channel shifted by three or less channels from the busy channel as the communication channel to be used by the access point when the plurality of communication channels are four or more and the received signal strength is higher than a predetermined value but lower than a predetermined threshold value.

8. The communication channel selection device of claim 1, wherein
the signal strength detector detects the received signal strength only for the busy channel detected by the channel detector.

9. A method of selecting a wireless communication channel among a plurality of communication channels with partially overlapping bandwidths in a frequency range available for use by an access point, comprising:
detecting a busy channel used by another access point different from the access point;
detecting with a signal strength detector a received signal strength of a wireless radio wave output from the another access point in the busy channel; and
checking for a presence of a non-interfering channel that does not interfere with the busy channel, and when the checking does not detect the presence of the non-interfering channel, selecting the communication channel to be used by the access point based on the received signal strength of the wireless radio wave output in the busy channel.

10. The method of claim 9, wherein
the non-interfering channel is a channel having an unused bandwidth of a predetermined size.

11. The method of claim 9, wherein
the checking for the presence of the non-interfering channel regards any channel having the received signal strength that is not higher than a predetermined value as a unused channel.

12. The method of claim 9, wherein
the selecting selects the busy channel as the communication channel to be used by the access point when the received signal strength of the busy channel is not lower than a predetermined threshold.

13. The method of claim 12, wherein
the selecting selects the busy channel as a channel to be used with collision avoidance control by the access point.

14. The method of claim 12, further comprising:
prohibiting selection of two busy channels among plural busy channels as the communication channel to be used by the access point, when the two busy channels are used by other access points in a mutually interfering range and mutually interfering frequency bands.

15. The method of claim 9, wherein
the selecting selects a peripheral channel shifted by three or less channels from the busy channel as the communication channel to be used by the access point when the plurality of communication channels are four or more and the received signal strength is higher than a predetermined value but lower than a predetermined threshold value.

16. The method of claim 9, wherein
the detecting detects the received signal strength only for the busy channel.

17. A non-transitory computer readable storage device having computer readable instructions stored therein that when executed by a processing circuit implement a method of selecting a wireless communication channel among a plurality of communication channels with partially overlapping bandwidths in a frequency range available for use by an access point, the method comprising:
detecting a busy channel used by another access point different from the access point;
detecting with a signal strength detector a received signal strength of a wireless radio wave output from the another access point in the busy channel; and
checking for a presence of a non-interfering channel that does not interfere with the busy channel, and when the checking does not detect the presence of the non-interfering channel, selecting the communication channel to be used by the access point based on the received signal strength of the wireless radio wave output in the busy channel.

18. The computer readable storage device of claim 17, wherein
the non-interfering channel is a channel having an unused bandwidth of a predetermined size.

19. The computer readable storage device of claim 17, wherein
the checking for the presence of the non-interfering channel regards any channel having the received signal strength that is not higher than a predetermined value as a unused channel.

20. The computer readable storage device of claim 17, wherein
the selecting selects the busy channel as the communication channel to be used by the access point when the received signal strength of the busy channel is not lower than a predetermined threshold.
